(19) United States
(12) Patent Application Publication
(10) Pub. No.: US 2024/0329183 A1
(43) Pub. Date: Oct. 3, 2024

(54) DILUTION OF PRECISION (DOP)-BASED SELECTION OF RECONFIGURABLE INTELLIGENT SURFACE (RIS)

(71) Applicant: QUALCOMM Incorporated, San Diego, CA (US)

(72) Inventors: Alexandros MANOLAKOS, Athens (GR); Weimin DUAN, San Diego, CA (US); Bala RAMASAMY, San Marcos, CA (US)

(21) Appl. No.: 18/579,260

(22) PCT Filed: May 27, 2022
(86) PCT No.: PCT/US2022/072623

§ 371 Date: Jan. 12, 2024

(30) Foreign Application Priority Data
Jul. 14, 2021 (GR) 20210100472

(51) Int. Cl. G01S 5/02; H04B 7/04

(52) U.S. Cl. CPC G01S 5/0273; H04B 7/04013

(57) ABSTRACT

Disclosed are techniques for wireless communication. In an aspect, a network node may determine an estimated location of a user equipment (UE) that is served by a serving base station (BS). The network node may determine a dilution of precision (DOP) requirement with respect to the UE. The network node may determine at least one reconfigurable intelligent surface (RIS) that satisfies the DOP requirement with respect to the UE. The network node may send at least one configuration message to configure the at least one RIS to reflect positioning reference signals to or from the UE. In another aspect, a UE may determine a DOP requirement with respect to the UE. The UE may send at least one configuration message to select at least one RIS that satisfies the DOP requirement with respect to the UE to reflect positioning reference signals to or from the UE.

### CROSS-REFERENCE TO RELATED APPLICATIONS

The present Application for Patent claims the benefit of GR Application No. 20210100472, entitled “DILUTION OF PRECISION (DOP)-BASED SELECTION OF RECONFIGURABLE INTELLIGENT SURFACE (RIS)”, filed Jul. 14, 2021, and is a national stage application, filed under 35 U.S.C. § 371, of International Patent Application No. PCT/US2022/072623, entitled, “DILUTION OF PRECISION (DOP)-BASED SELECTION OF RECONFIGURABLE INTELLIGENT SURFACE (RIS)”, filed May 27, 2022, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data. Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), calls for higher data transfer speeds, greater numbers of connections, and better coverage, among other improvements. The SG standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of SG mobile communications should be significantly enhanced compared to the current 4G standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a network node includes determining an estimated location of a user equipment (UE) that is served by a serving base station (BS); determining a dilution of precision (DOP) requirement with respect to the UE; determining at least one reconfigurable intelligent surface (RIS) that satisfies the DOP requirement with respect to the UE; sending at least one configuration message to configure the at least one RIS to reflect positioning reference signals to or from the UE.

In an aspect, a method of wireless communication performed by a user equipment (UE) includes determining a dilution of precision (DOP) requirement with respect to the UE; sending at least one configuration message to select at least one RIS that satisfies the DOP requirement with respect to the UE to reflect positioning reference signals to or from the UE.

In an aspect, an apparatus comprises a memory, at least one transceiver, and at least one processor communicatively coupled to the memory and the at least one transceiver, the at least one processor configured to perform any of the methods disclosed herein.

In an aspect, an apparatus comprises means for performing any of the methods disclosed herein.

In an aspect, a computer-readable medium stores computer-executable instructions, the computer-executable instructions comprising at least one instruction for causing an apparatus to perform any of the methods disclosed herein.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIGS. 4A and 4B illustrate the use of a reconfigurable intelligent surface (RIS) to extend 5G coverage with negligible power consumption.

FIG. 5 illustrates another use of RIS, in which a base station controls many spatially separated small RISs, rather than a few large RISs, to redirect beams as reflected beams towards UEs.

FIG. 6 illustrates an association of a PBS resource with multiple antenna point locations.

FIGS. 7A, 7B, and 7C illustrate multiple RPOs with different RPO-IDs having the same location and frequency band but different beam directions.

FIGS. 8A and 8B illustrate how the quality of a positioning estimate can differ based on the angle between the two transmitters relative to the receiver.

FIG. 9 is a flowchart of an example process, which may be performed by a network node, associated with DOP-based selection of RIS according to some aspects of the disclosure.

FIG. 10 is a flowchart of an example process, which may be performed by a UE, associated with DOP-based selection of RIS according to some aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

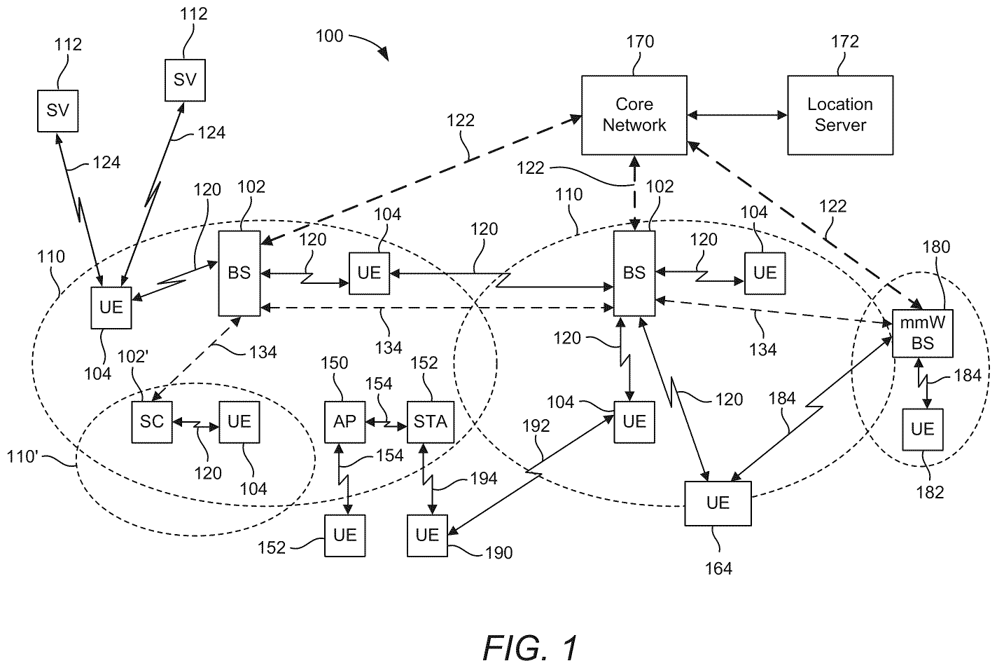

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/SGC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen-before-talk (LBT) procedure prior to communicating in order to determine whether the channel is available.

The small cell base station 102 may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel, if the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2), mmW frequency bands generally include the FR2. FR3, and FR4 frequency ranges. As such, the terms “mmW” and “FR2” or “FR3” or “FR4” may generally be used interchangeably.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

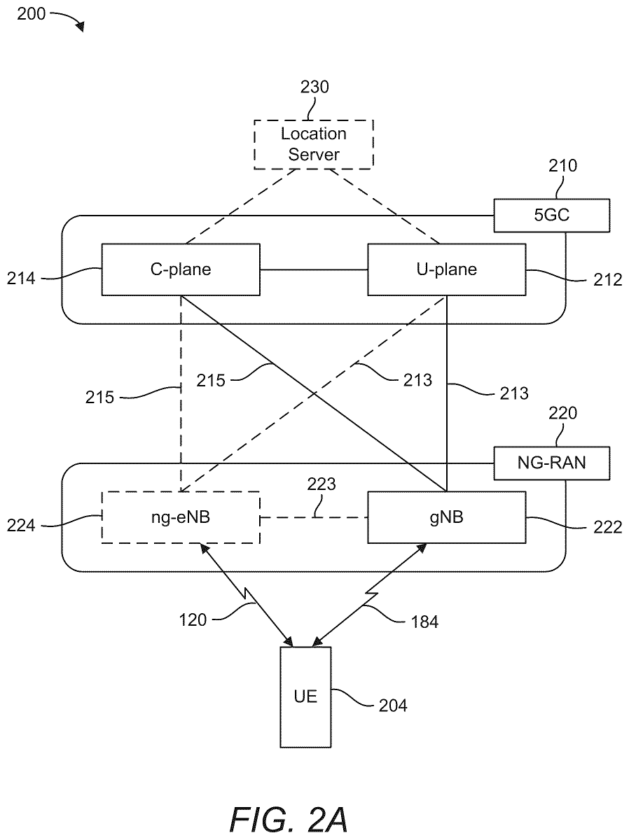

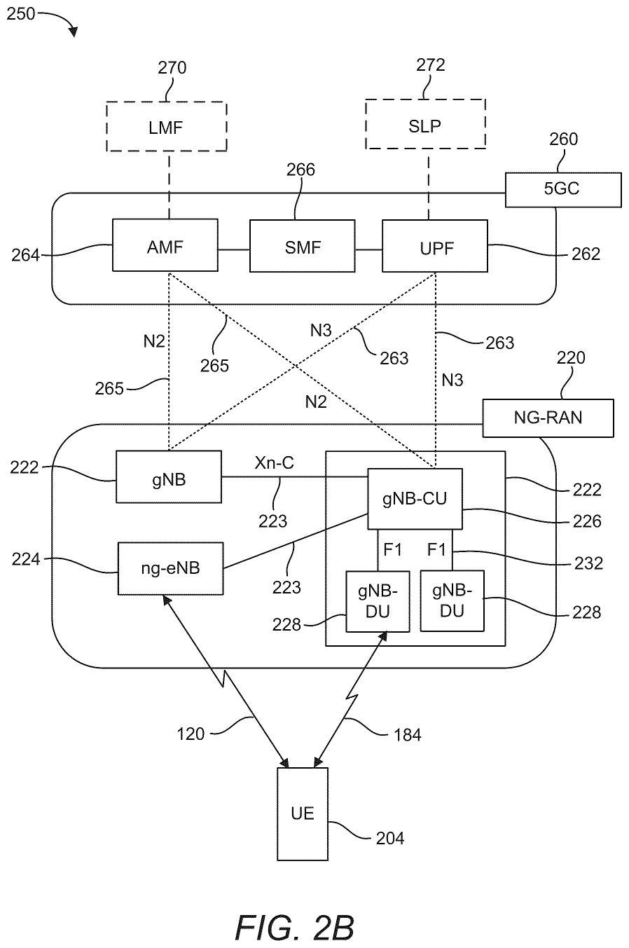

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212. (e.g., UE gateway function, access to data networks, IP routing, etc.) which operate cooperatively to form the core network. User plane interface (NG-U) 213 and control plane interface (NG-C) 215 connect the gNB 222 to the SGC 210 and specifically to the user plane functions 212 and control plane functions 214, respectively. In an additional configuration, an ng-eNB 224 may also be connected to the SGC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the SGC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third-party server, such as an original equipment manufacturer (OEM) server or service server).

FIG. 2B illustrates another example wireless network structure 250. A 5GC 260 (which may correspond to SGC 210 in FIG. 2A) can be viewed functionally as control plane functions, provided by an access and mobility management function (AMF) 264, and user plane functions, provided by a user plane function (UPF) 262, which operate cooperatively to form the core network (i.e., SGC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management. UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the Nil interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to cam, voice and/or data like the transmission control protocol (TCP) and/or IP).

User plane interface 263 and control plane interface 265 connect the SGC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may, communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 is divided between a gNB central unit (gNB-CU) 226 and one or more gNB distributed units (gNB-DUs) 228. The interface 232 between the gNB-CU 226 and the one or more gNB-DUs 228 is referred to as the “F1” interface. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 hosts the radio resource control (RRC), service data adaptation protocol (SDAP), and packet data convergence protocol (PDCP) protocols of the gNB 222. A gNB-DU 228 is a logical node that hosts the radio link control (RLC), medium access control (MAC), and physical (PHY) layers of the gNB 222. Its operation is controlled by the gNB-CU 226. One gNB-DU 228 can support one or more cells, and one cell is supported by only one gNB-DU 228. Thus, a UE 204 communicates with the gNB-CU 226 via the RRC. SDAP, and PDCP layers and with a gNB-DU 228 via the RLC, MAC, and PHY layers.

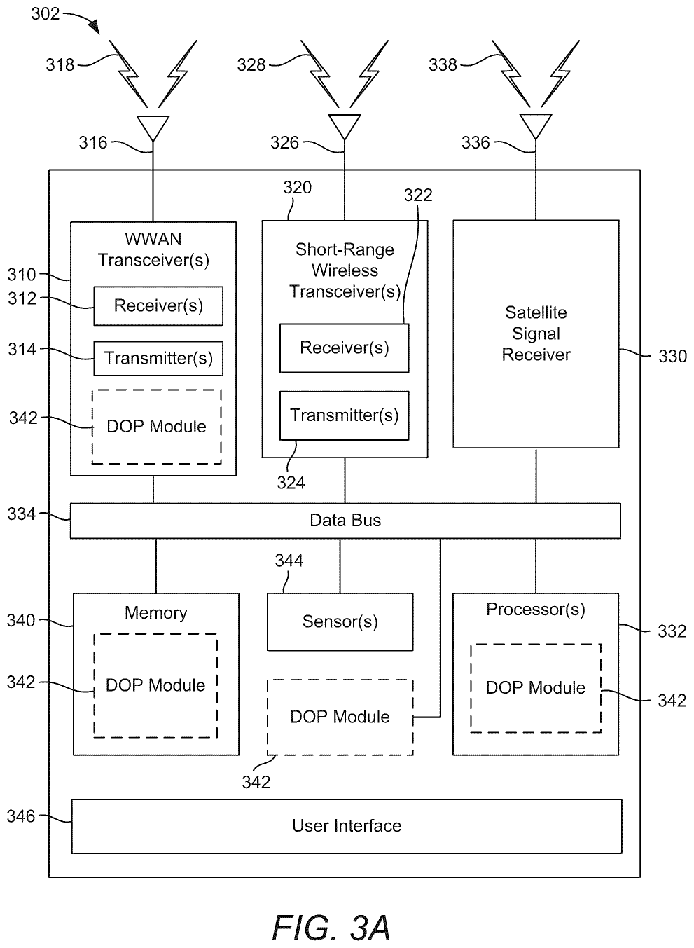

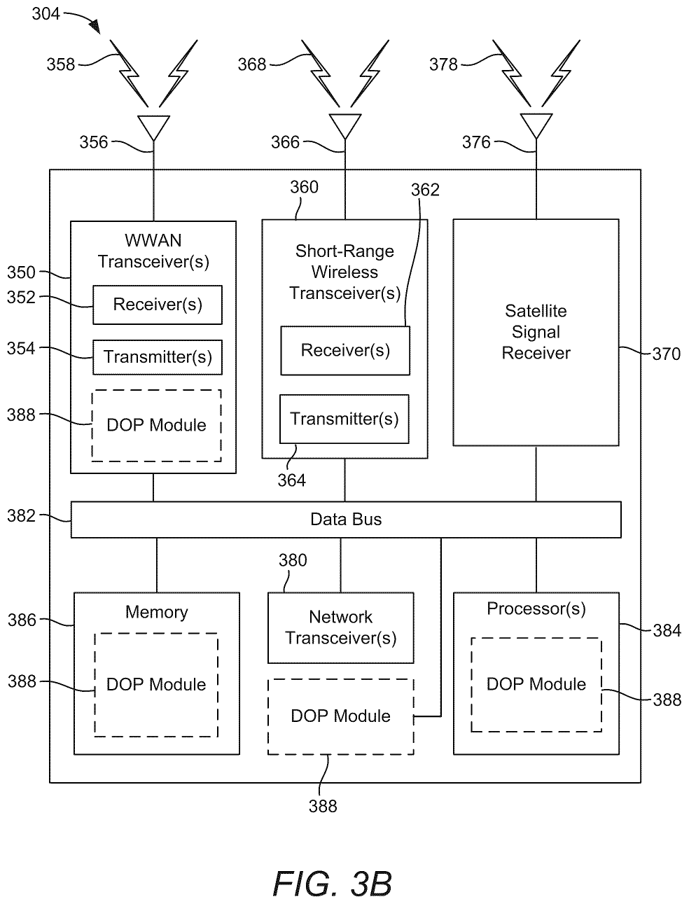

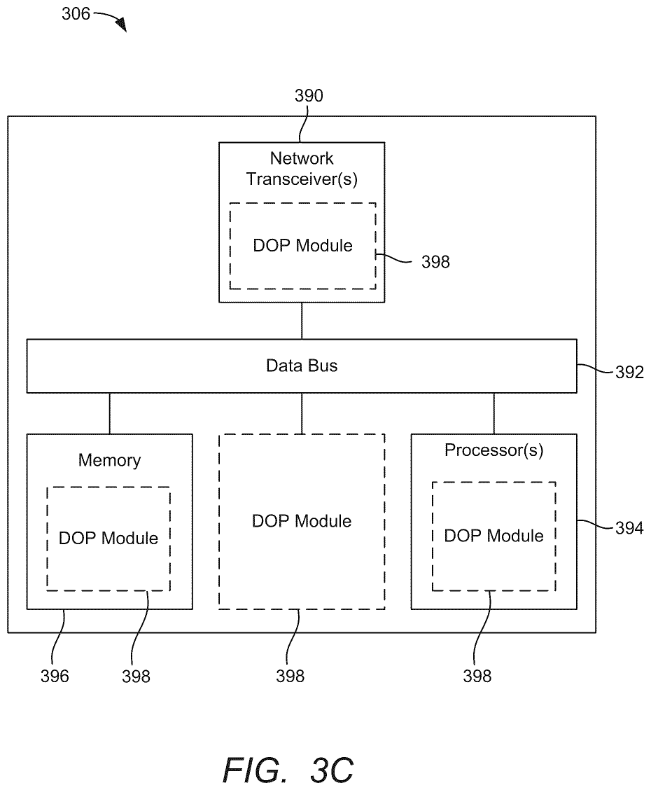

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include a dilution of precision (DOP) module 342, 388, and 398, respectively. The DOP module 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the DOP module 342, 388, and 398 may be external to the processors 332, 384, and 394 (e.g., part of a modem processing system, integrated with another processing system, etc.). Alternatively, the DOP module 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the DOP module 342, which may be, for example, part of the one or more WWAN transceivers 310, the memory 340, the one or more processors 332, or any combination thereof, or may be a standalone component. FIG. 3B illustrates possible locations of the DOP module 388, which may be, for example, part of the one or more WWAN transceivers 350, the memory 386, the one or more processors 384, or any combination thereof, or may be a standalone component. FIG. 3C illustrates possible locations of the DOP module 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base, station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)). RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference, signal (e.g., pilot) in the time and/or frequency domain, and then combined together using an inverse fast Fourier transform (IFFY) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the DOP module 342, 388, and 398, etc.

In some designs, the network entity 306 may be implemented as a core network component. In other designs, the network entity 306 may be distinct from a network operator or operation of the cellular network infrastructure (e.g., NG RAN 220 and/or SGC 210/260). For example, the network entity 306 may be a component of a private network that may be configured to communicate with the UE 302 via the base station 304 or independently from the base station 304 (e.g., over a non-cellular communication link, such as WiFi).

Fifth Generation (5G) massive multiple-input, multiple-output (MIMO) is a key enabler for increasing throughput. High beamforming gain is achieved by using active antenna units (AAUs) and individual radio frequency (RF) chains per antenna ports. However, this results in a significant increase in power consumption.

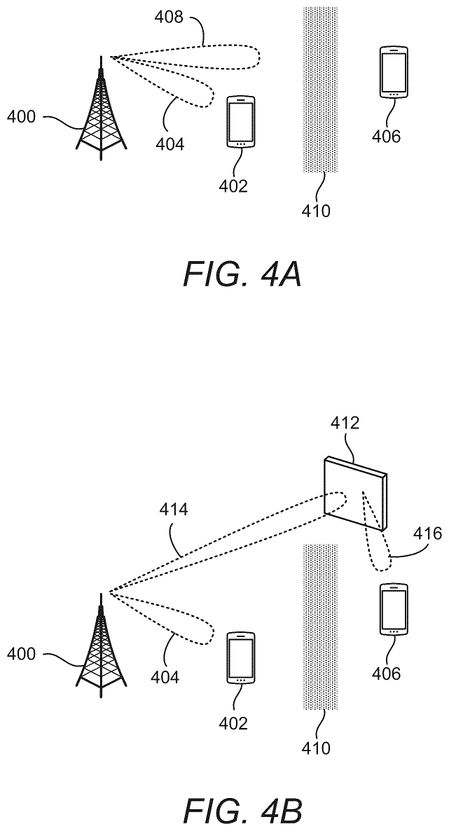

FIGS. 4A and 4B illustrate the use of a reconfigurable intelligent surface (RIS) to extend 5G coverage with negligible power consumption. A RIS is a near-passive device that reflects an impinging wave to a desired direction. FIG. 4A illustrates a scenario where a gNB 400 can reach a first UE 402 via a first transmission beam 404, but cannot communicate with a second UE 406 because a second transmission beam 408 transmitted in the direction of the second UE 406 is blocked by an obstacle 410. In FIG. 4B, by using a RIS 412 that is controlled by the gNB 400, the gNB 400 can reach the second UE 406 by transmitting a third beam 414 towards the RIS 412, which sends a reflected beam 416 around the obstacle 410 towards the second UE 406.

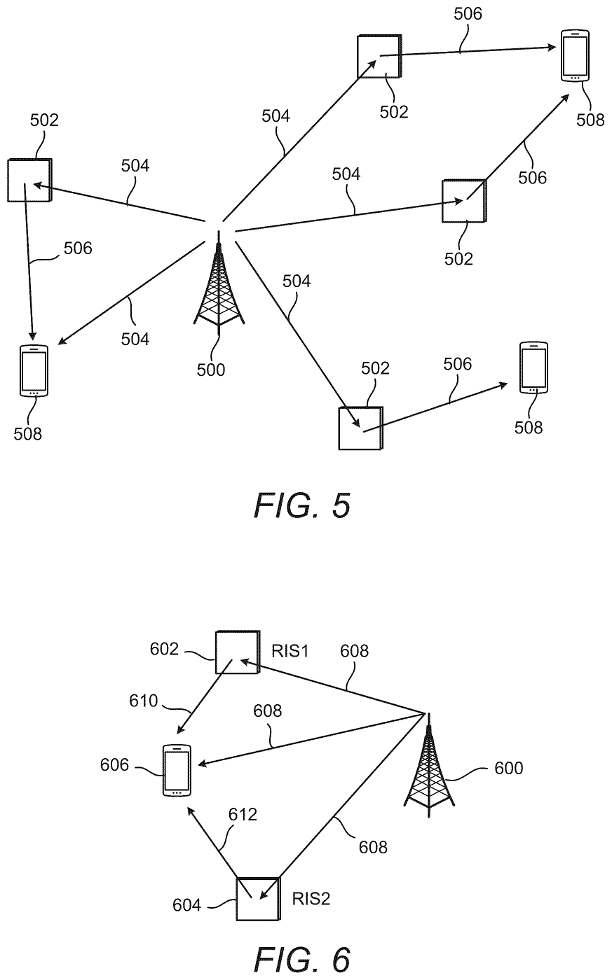

FIG. 5 illustrates another use of RIS, in which a gNB 500 controls many spatially separated small RISs, rather than a few large RISs, to redirect beams 504 as reflected beams 506 towards UEs 508. In this approach, each UE 508 can be associated with one or more RISs 502. A direct link between the gNB 500 and a UE 508 may also be used. Using multiple smaller RISs 502 instead of one large RIS offers better spatial diversity but may also create a noisier environment.

FIG. 6 illustrates an association of a PRS resource with multiple antenna point locations. In the example shown in FIG. 6, a network includes a gNB 600, a first RIS 602, a second RIS 604, and a UE 606. Each RIS may or may not be controllable by the gNB 600, e.g., the gNB 600 may or may not be able to control the direction at which the RIS reflects an impinging wave. In the example shown in FIG. 6, a PRS beam 608 is received directly by the UE 606 and indirectly as a reflected beam 610 from the first RIS 602 and as a reflected beam 612 from the second RIS 604.

A common positioning and sensing signaling framework may be used to notify the UE 606 of an association of the PRS resource with multiple antenna reference point (ARP) locations, some of which may be reflection locations, and which may also be called reflection point objects (RPOs). An RPO may be controllable by the network (e.g., a RIS controlled by the gNB) or non controllable by the network (e.g., a RIS controlled by another network, a RIS whose reflection direction is fixed and cannot be changed, or a building or other object that has been identified as one that reflects radio signals). An RPO (e.g., RIS, building, or other reflecting entity) may have a known location or an unknown location. This signaling framework may be general enough to enable associating a PRS resource with all of these kinds of RPOs.

Such a generic framework can be enabled by providing an association of a PRS resource having a transmission reception point (TRP) location to a list of RPOs, each RPO having an RPO-ID and a point location, if known. An example is shown below:

PRS resource 1 - location

| | |
|---|---|
| ARP-Location = TRP Location | (location of gNB 600) |
| ARP-Location-Reflection1 = RIS1 Location | (location of RIS 602) |
| ARP-Location-Reflection2 = RIS2 Location | (location of RIS 604) |

...

This framework may be provided as part of assistance data to the UE 606.

In some aspects, the assistance data can include a collection of RPOs, where each RPO may be associated with one or more of the following: an RPO-ID, a specific frequency band (FR) of applicability, or a unique location in geographic space. The RPO information (e.g., without any association to PRS resources/sets/PLFs/TRPs may be sent in a separate positioning system information block (posSIB) as a broadcast or unicast message. An example of RPO information is shown below:

```
RPO-Info:
  RPO1: {Location1, FR1, ID=0}
  RPO2: {Location2, FR2, ID=1}
  ...
```

The ARP of a PRS resource may be associated with multiple RPOs by pointing to the index, such as shown in the example below:

```
PRS resource 1 - location
  ARP-Location = TRP Location
  ARP-Location-Reflection1 = RPO1-ID
  ARP-Location-Reflection2 = RPO2-ID
  ...
```

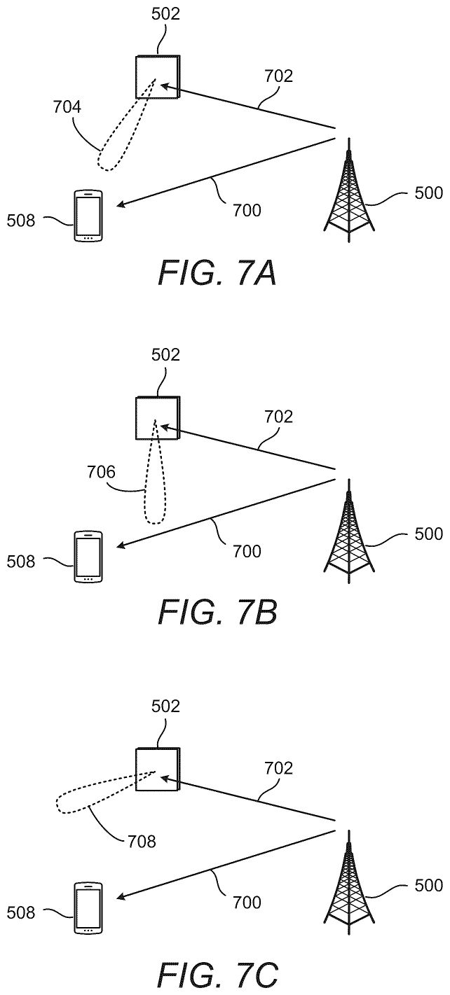

FIGS. 7A, 7B, and 7C illustrate the point that multiple RPOs with different RPO-IDs may have the same location and frequency band but different beam directions, as can happen when a RIS has a configurable reflected beam direction. In each of FIGS. 7A through 7C, a gNB 500, which is serving a UE 508, controls a controllable RIS 502. The gNB 500 transmits a first signal 700 towards the UE 508 and transmits a second signal 702 towards the RIS 502. In some cases, the first signal 700 and the second signal 702 may be the same signal or transmitted at the same time. In FIG. 7A, the second signal 702 is reflected as a beam 704 having a first angle, e.g., directed towards the UE 508. In FIG. 7B, the second signal 702 is reflected as a beam 706 having a second angle, e.g., not directed towards the UE 508, and in FIG. 7C, the second signal 702 is reflected as a beam 708 having a third angle, e.g., also not directed towards the UE 508. In the example shown in FIG. 7A, each of beams 704, 706, and 708 may have different RPO-IDs. For example, beam 704 may have an RPO-ID=0, beam 706 may have an RPO-ID=1, and beam 708 may have an RPO-ID=3. An example of the corresponding RPO information is shown below:

```
RPO-Info:
  RPO1: {Location1, FR1, ID=0}
  RPO2: {Location1, FR1, ID=1}
  RPO3: {Location1, FR1, ID=2}
```

As shown above, the three RPOs have the same location and frequency range but different IDs. In some aspects, the RPO information for each beam may also include a reflection angle.

### Dilution of Precision

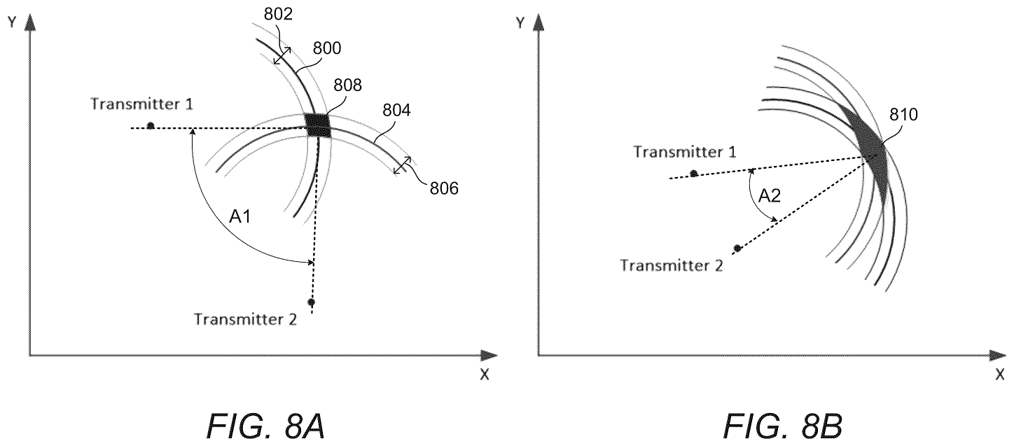

The quality of positioning that can be obtained from a group of gNBs (nodes in general) can be quantified using a dilution of precision (DOP) metric. Put simply, when performing triangulation, trilateration, or multilateration based on measurements from a set of signals that are transmitted from different angles relative to the receiver, a larger relative angle is better than a smaller relative angle. This is illustrated in FIGS. 8A and 8B.

FIGS. 8A and 8B illustrate how the quality of a positioning estimate, e.g., the position precision, can differ based on the angle between the two transmitters relative to the receiver. The relative angles between the transmitters are labeled “A1” in FIG. 8A and “A2” in FIG. 8B. In this examples shown in FIGS. 8A and 8B, A1 is greater than A2. In FIG. 8A, an estimated distance from transmitter 1 is shown as the line 800, and this distance estimate has an uncertainty 802. Likewise, an estimated distance from transmitter 2 is shown as line 804, with an uncertainty 806. This results in an area 808, shown as the black filled shape at the intersection of the measurements with uncertainty, in which the UE could be located. In FIG. 8B, the estimated distances and uncertainties are the same as for FIG. 8A, but the smaller angle A2 results in an area 810 that is larger area than the area 808 in FIG. 8A. Since area 810 is larger than area 808, the precision of the estimate in FIG. 8B is less than the precision of the estimate in FIG. 8A.

The DOP metric has several variants, such as:
Geometric DOP (GDOP): 3D positioning+timing uncertainty
Horizontal DOP (HDOP): for horizontal positioning
Vertical DOP (VDOP): for vertical positioning
Position DOP (PROP): for 3D positioning only
Timing DOP (TROP): timing uncertainty only
   Computing the metric requires the positions of the gNBs (reference nodes) and a rough location of the UE.

For example, the geometric dilution of precision (GDOP) is the ratio of the standard deviation of errors in the least-squares solution to the standard deviation of the measurement errors. For the two-dimensional example shown in the figure, GDOP is given by:

$$GDOP = \frac{\sqrt{{σ}_{x}^{2} + {σ}_{y}^{2}}}{{σ}_{meas}} = \frac{\sqrt{trace \{ {( {G}^{T} G )}^{- 1} \}}}{{σ}_{meas}}$$

where \sqrt{σₓ²+σ_{y}²} characterizes the location error, and σₘₑₐₛ² is the measurement error variance. Different positioning method results in different matrix G, for example, for ToA based method, G is given as

$$G = [ \begin{matrix}\frac{( x - {x}_{1} )}{\sqrt{{( x - {x}_{1} )}^{2} + {( y - {y}_{1} )}^{2}}} & \frac{( y - {y}_{1} )}{\sqrt{{( x - {x}_{1} )}^{2} + {( y - {y}_{1} )}^{2}}} \\ \frac{( x - {x}_{2} )}{\sqrt{{( x - {x}_{2} )}^{2} + {( y - {y}_{2} )}^{2}}} & \frac{( y - {y}_{2} )}{\sqrt{{( x - {x}_{2} )}^{2} + {( y - {y}_{2} )}^{2}}} \\ ⋮ & ⋮ \\ \frac{( x - {x}_{N} )}{\sqrt{{( x - {x}_{N} )}^{2} + {( y - {y}_{N} )}^{2}}} & \frac{( y - {y}_{N} )}{\sqrt{{( x - {x}_{N} )}^{2} + {( y - {y}_{N} )}^{2}}}\end{matrix} ]$$

For low latency positioning and on-demand positioning, especially in dense networks, the UE may not be required to process the PRS from all the gNBs for its positioning. Instead, a subset of gNBs could be selected which satisfy a quality metric may be sufficient. However, current standards do not support or even contemplate such an operation.

To address this technical deficiency, a mechanism and the necessary signaling to enable such as feature are herein presented. For example, good GDOP is typically tied to the spatial distribution of the nodes transmitting the positioning signal and the measurement uncertainty for each link. Adding a node whose position is highly correlated with other nodes does not improve the positioning quality by much; nor does adding a node with good relative spatial diversity but with a poor signal quality due to bad visibility, line of sight (LOS) obstacles, interference, etc. In dense deployments with signals from several strong gNBs, however, a subset of gNBs may be selected for use to compute position estimates based on DOP criteria.

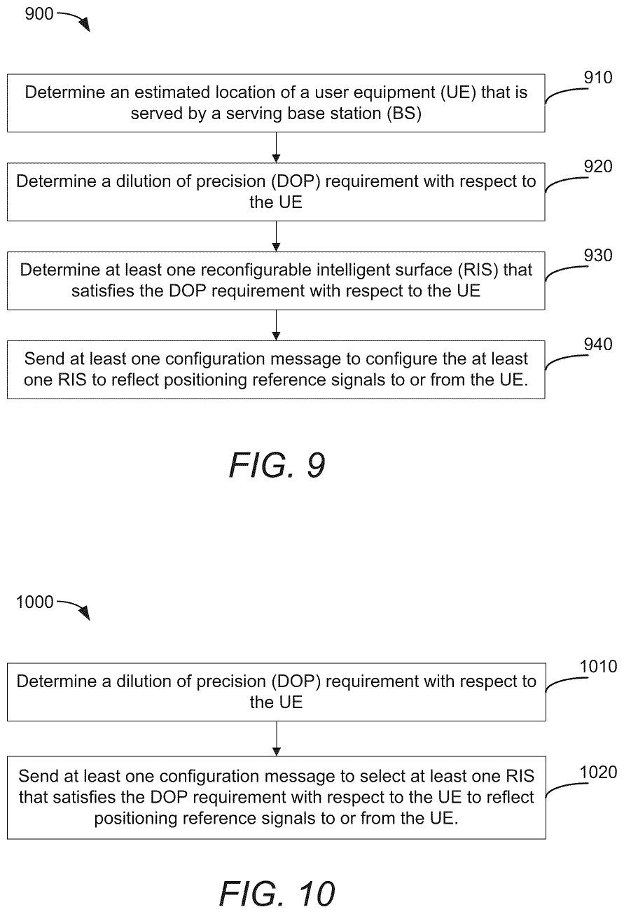

FIG. 9 is a flowchart of an example process 900 associated with DOP-based selection of RIS according to some aspects of the disclosure. In some implementations, one or more process blocks of FIG. 9 may be performed by a network node (e.g., location server 172, LMF 270, etc.). In some implementations, one or more process blocks of FIG. 9 may be performed by another device or a group of devices separate from or including the network node. Additionally, or alternatively, one or more process blocks of FIG. 9 may be performed by one or more components of network node 306, such as processor(s) 394, memory 396, network transceiver(s) 390, or DOP module(s) 398, any or all of which may comprise means for performing this operation.

As shown in FIG. 9, process 900 may include determining an estimated location of a user equipment (UE) that is served by a serving base station (BS) (block 910). Means for performing the operation of block 910 may include the processor(s) 394, memory 396, and network transceiver(s) 390 of network node 306. For example, the processor(s) 394 of network node 306 may determine an estimated location of a UE based on information received from the UE or the serving base station via the network transceiver(s) 390 and stored in memory 396.

As further shown in FIG. 9, process 900 may include determining a dilution of precision (DOP) requirement with respect to the UE (block 920).

Means for performing the operation of block 920 may include the processor(s) 394, memory 396, and network transceiver(s) 390 of the network node 306. For example, the processor(s) 394 may determine a DOP requirement based on a QoS requirement associated with the UE, which was received via the network transceiver(s) 390 and stored in memory 396. In some aspects, the DOP requirement with respect to the UE comprises a geometric DOP (GDOP) requirement (which includes both position and timing precision requirements), a horizontal DOP (HDOP) requirement, a vertical DOP (VDOP) requirement, a position DOP (PDOP) requirement, a timing DOP (TROP) requirement, or combinations thereof. For example, if the QoS requires vertical positioning, the RIS location may need to be known in three dimensions (3D) in order to determine whether that RIS has good VDOP. Likewise, if the QoS requires horizontal positioning, the RIS location may need to be known in two dimensions (2D) in order to determine whether the RIS has good HDOP.

As further shown in FIG. 9, process 900 may include determining at least one reconfigurable intelligent surface (RIS) that satisfies the DOP requirement with respect to the UE (block 930). Means for performing the operation of block 930 may include the processor(s) 394 and memory 396 of the network node 306.

In some aspects, the network node 306 may identify at least one RIS that satisfies the DOP requirement with respect to the UE by selecting the at least one RIS that satisfies the DOP requirement with respect to the UE from a list of RISs with known locations. Knowing the location of a RIS allows the processor(s) 394 to calculate a DOP value based on the location of the serving base station and the RIS. The processor(s) 394 can then determine whether that RIS provides a DOP value that satisfies the DOP requirement.

In some aspects, determining the at least one RIS that satisfies a DOP requirement with respect to the UE comprises identifying at least one geographical region from which a RIS would satisfy the DOP requirement with respect to the UE; sending, to a RIS controller (e.g., a base station or another RAN node), the at least one geographical region, receiving, from the RIS controller, an identity of at least one RIS within the at least one geographical region; and determining whether or not the at least one RIS satisfies the DOP requirement with respect to the UE, e.g., by calculating or otherwise determining the DOP value for a pair comprising the serving base station and a RIS. If the RIS satisfies the DOP requirement, that RIS can be selected. In some aspects, the network node 306 also sends the DOP requirement to the RIS controller, e.g., when the network node 306 sends the geographical region, and the RIS controller identifies RISs that satisfy that DOP requirement. Alternatively the DOP requirement can be determined by the RIS controller, e.g., based on a QoS value associated with the UE.

In some aspects, determining the at least one RIS that satisfies a DOP requirement with respect to the UE comprises sending, to a RIS controller (e.g., a base station or RAN node), the estimated location of the UE and the DOP requirement with respect to the UE, and receiving, from the RIS controller, an identity of at least one RIS that satisfies the DOP requirement with respect to the UE.

Depending on the different vertical and horizontal requirements, different RIS subsets may be requested. For example, in some aspects, determining the at least one RIS that satisfies a DOP requirement with respect to the UE comprises determining a first set of one or more RISs that satisfy a first DOP requirement with respect to the UE, and determining a second set of one or more RISs that satisfy a second DOP requirement with respect to the UE. For example, one RIS may be selected because it satisfies a VDOP requirement while another RIS may also be selected because it satisfies a HDOP requirement.

As further shown in FIG. 9, process 900 may include sending at least one configuration message to configure the at least one RIS to reflect positioning reference signals to or from the UE (block 940). Means for performing the operation of block 940 may include the network transceiver(s) 390 of network node 306. For example, the network node 306 may send at least one configuration message via the network transceiver(s) 390. In some aspects, sending at least one configuration message to configure the at least one RIS to reflect positioning reference signals to or from the UE comprises sending the at least one configuration message to the at least one RIS. In some aspects, sending at least one configuration message to configure the at least one RIS to reflect positioning reference signals to or from the UE comprises sending the at least one configuration message to a network node that controls the at least one RIS, such as a base station, for example.

In some aspects, the at least one configuration message identifies the UE. In some aspects, the at least one configuration message indicates a location of the UE. In some aspects, the at least one configuration message indicates a direction in which to reflect the positioning reference signals to or from the UE. In some aspects, the at least one configuration message indicates a target accuracy level. In some aspects, process 900 includes sending at least one configuration message to configure the serving BS to transmit at least one positioning reference signal to the at least one RIS. In some aspects, process 900 includes receiving at least one configuration response message indicating that the at least one RIS is or is not configured to reflect positioning reference signals to or from the UE. In some aspects, the network node comprises a location server.

Process 900 may include additional implementations, such as any single implementation or any combination of implementations described below and/or in connection with one or more other processes described elsewhere herein. Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a flowchart of an example process 1000 associated with DOP-based selection of RIS according to some aspects of the disclosure. In some implementations, one or more process blocks of FIG. 10 may be performed by a UE (e.g., UE 104, etc.). In some implementations, one or more process blocks of FIG. 10 may be performed by another device or a group of devices separate from or including the user equipment (UE). Additionally, or alternatively, one or more process blocks of FIG. 10 may be performed by one or more components of UE 302, such as processor(s) 332, memory 340, WWAN transceiver(s) 310, short-range wireless transceiver(s) 320, satellite signal receiver 330, or DOP module(s) 342, any or all of which may comprise means for performing this operation.

As shown in FIG. 10, process 1000 may include determining a dilution of precision (DOP) requirement with respect to the UE (block 1010). Means for performing the operation of block 1010 may include the processor(s) 332 and memory 340 of the UE 302. For example, the processor(s) 332 of the UE 302 may determine a dilution of precision (DOP) requirement based on information about the UE 302 stored in the memory 340. In some aspects, determining the DOP requirement comprises determining the DOP requirement based on a quality of service (QoS) requirement associated with the UE. In some aspects, the DOP requirement with respect to the UE comprises a geometric DOP requirement, a horizontal DOP requirement, a vertical DOP requirement, a position DOP requirement, a timing DOP requirement, or combinations thereof.

As further shown in FIG. 10, process 1000 may include sending at least one configuration message to select at least one RIS that satisfies the DOP requirement with respect to the UE to reflect positioning reference signals to or from the UE (block 1020). Means for performing the operation of block 1020 may include the WWAN transceiver(s) 310 of the UE 302. For example, the UE 302 may send the at least one configuration message via transmitter(s) 314. In some aspects, the at least one configuration message comprises information that identifies at least one RIS that satisfies the DOP requirement with respect to the UE. In some aspects, the at least one configuration message further comprises an estimated location of the UE. In some aspects, the at least one configuration message comprises the DOP requirement and an estimated location of the UE.

In some aspects, sending at least one configuration message comprises selecting the at least one RIS that satisfies the DOP requirement with respect to the UE and sending the at least one configuration message to the at least one RIS that satisfies the DOP requirement with respect to the UE.

In some aspects, sending at least one configuration message comprises sending the at least one configuration message to a RIS controller that selects the at least one RIS that satisfies the DOP requirement with respect to the UE. In some aspects, the RIS controller comprises a base station or a radio access network node.

In some aspects, sending the at least one configuration message comprises sending the at least one configuration message to a location server. In some aspects, process 1000 includes receiving, from the location server, information that associates a RIS with a positioning reference signal (PRS) resource, PRS resource set, transmission reception point (TRP), positioning frequency layer (PFL), or combinations thereof.

Process 1000 may include additional implementations, such as any single implementation or any combination of implementations described below and/or in connection with one or more other processes described elsewhere herein. Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

FIG. 10 illustrates an example UE-based process. For example, a UE may want to perform a positioning operation or start a positioning session. If the UE is aware of the potential RIS locations, it may identify RISs that satisfy a DOP requirement and send requests directly to those RISs, or to a RIS controller that controls those RISs. Alternatively, the RIS controller may decide which RISs satisfy the DOP requirement. The UE may include in a request a first location estimate & a target accuracy level, and then a location server or other network node is responsible to switch on or off specific RISs, e.g., as described in FIG. 9. If the location server is not aware of the locations of the RIS, it may include in the request a geographic location/zone-ID of where a RIS should be enabled. The RIS controller or the RAN, gNB would reply positively or negatively, whether this is possible.

The request may have a few steps. For example, in some aspects, the LMF requests which RIS are available in a specific region or associated to a specific TRP, PRS resource set, PFL, and/or PRS resource, potentially for a duration of time/timestamp; the RAN, RIS controller, gNB, or TRP, replies with a set of RIS (or generally Reflective Objects List or ID), potentially In a priority ordering; and the LMF sends a final request of which RIS to be associated with which PRS resource, PRS resource set, TRP, and/or PFL.

As will be appreciated, a technical advantage of the methods 900 and 1000 is that, by considering whether or not a particular RIS provides a good DOP value, a subset of RISs can be selected for positioning such that the UE saves power (e.g., by using some, but not all of the available RISs) yet maintains good positioning accuracy (e.g., by selecting a set of RISs that have good spatial diversity from each other relative to the UE).

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a network node, the method comprising: determining an estimated location of a user equipment (UE) that is served by a serving base station (BS); determining a dilution of precision (DOP) requirement with respect to the UE; determining at least one reconfigurable intelligent surface (RIS) that satisfies the DOP requirement with respect to the UE; sending at least one configuration message to configure the at least one RIS to reflect positioning reference signals to or from the UE.

Clause 2. The method of clause 1, wherein determining the DOP requirement comprises determining the DOP requirement based on a quality of service (QoS) requirement associated with the UE.

Clause 3. The method of any of clauses 1 to 2, wherein the DOP requirement with respect to the UE comprises a geometric DOP requirement, a horizontal DOP requirement, a vertical DOP requirement, a position DOP requirement, a timing DOP requirement, or combinations thereof.

Clause 4. The method of any of clauses 1 to 3, wherein determining the at least one RIS that satisfies a DOP requirement with respect to the UE comprises: identifying at least one RIS that satisfies the DOP requirement with respect to the UE.

Clause 5. The method of clause 4, wherein identifying the at least one RIS that satisfies the DOP requirement with respect to the UE comprises selecting the at least one RIS that satisfies the DOP requirement with respect to the UE from a list of RISs with known locations.

Clause 6. The method of any of clauses 1 to 5, wherein determining the at least one RIS that satisfies a DOP requirement with respect to the UE comprises: identifying at least one geographical region from which a RIS would satisfy the DOP requirement with respect to the UE; sending, to a RIS controller, the at least one geographical region; receiving, from the RIS controller, an identity of at least one RIS within the at least one geographical region; and determining that the at least one RIS satisfies the DOP requirement with respect to the UE.

Clause 7. The method of clause 6, further comprising sending the DOP requirement to the RIS controller, wherein the at least one RIS identified by the RIS controller satisfies the DOP requirement with respect to the UE.

Clause 8. The method of any of clauses 6 to 7, wherein the RIS controller comprises a base station or a radio access network node.

Clause 9. The method of any of clauses 1 to 8, wherein determining the at least one RIS that satisfies a DOP requirement with respect to the UE comprises: sending, to a RIS controller, the estimated location of the UE and the DOP requirement with respect to the UE; and receiving, from the RIS controller, an identity of at least one RIS that satisfies the DOP requirement with respect to the UE.

Clause 10. The method of clause 9, wherein the RIS controller comprises a base station or a radio access network node.

Clause 11. The method of any of clauses 1 to 10, wherein determining the at least one RIS that satisfies a DOP requirement with respect to the UE comprises: determining a first set of one or more RISs that satisfy a first DOP requirement with respect to the UE; and determining a second set of one or more RISs that satisfy a second DOP requirement with respect to the UE.

Clause 12. The method of any of clauses 1 to 11, wherein sending at least one configuration message to configure the at least one RIS to reflect positioning reference signals to or from the UE comprises sending the at least one configuration message to the at least one RIS.

Clause 13. The method of any of clauses 1 to 12, wherein sending at least one configuration message to configure the at least one RIS to reflect positioning reference signals to or from the UE comprises sending the at least one configuration message to a network node that controls the at least one RIS.

Clause 14. The method of clause 13, wherein sending the at least one configuration message to a network node that controls the at least one RIS comprises sending the at least one configuration message to a base station.

Clause 15. The method of any of clauses 1 to 14, wherein the at least one configuration message identifies the UE.

Clause 16. The method of any of clauses 1 to 15, wherein the at least one configuration message indicates a location of the UE.

Clause 17. The method of any of clauses 1 to 16, wherein the at least one configuration message indicates a direction in which to reflect the positioning reference signals to or from the UE.

Clause 18. The method of any of clauses 1 to 17, wherein the at least one configuration message indicates a target accuracy level.

Clause 19. The method of any of clauses 1 to 18, further comprising sending at least one configuration message to configure the serving BS to transmit at least one positioning reference signal to the at least one RIS.

Clause 20. The method of any of clauses 1 to 19, further comprising receiving at least one configuration response message indicating that the at least one RIS is or is not configured to reflect positioning reference signals to or from the UE.

Clause 21. The method of any of clauses 1 to 20, wherein the network node comprises a location server.

Clause 22. A method of wireless communication performed by a user equipment (UE), the method comprising: determining a dilution of precision (DOP) requirement with respect to the UE; sending at least one configuration message to select at least one RJS that satisfies the DOP requirement with respect to the UE to reflect positioning reference signals to or from the UE.

Clause 23. The method of clause 22, wherein determining the DOP requirement comprises determining the DOP requirement based on a quality of service (QoS) requirement associated with the UE.

Clause 24. The method of any of clauses 22 to 23, wherein the DOP requirement with respect to the UE comprises a geometric DOP requirement, a horizontal DOP requirement, a vertical DOP requirement, a position DOP requirement, a timing DOP requirement, or combinations thereof.

Clause 25. The method of any of clauses 22 to 24, wherein the at least one configuration message comprises information that identifies at least one RIS that satisfies the DOP requirement with respect to the UE.

Clause 26. The method of clause 25, wherein the at least one configuration message further comprises an estimated location of the UE.

Clause 27. The method of any of clauses 25 to 26, wherein sending at least one configuration message comprises selecting the at least one RIS that satisfies the DOP requirement with respect to the UE and sending the at least one configuration message to the at least one RIS that satisfies the DOP requirement with respect to the UE.

Clause 28. The method of any of clauses 22 to 27, wherein sending at least one configuration message comprises sending the at least one configuration message to a RIS controller that selects the at least one RIS that satisfies the DOP requirement with respect to the UE.

Clause 29. The method of clause 28, wherein the RIS controller comprises a base station or a radio access network node.

Clause 30. The method of any of clauses 22 to 29, wherein the at least one configuration message comprises the DOP requirement and an estimated location of the UE.

Clause 31. The method of any of clauses 22 to 30, wherein sending the at least one configuration message comprises sending the at least one configuration message to a location server.

Clause 32. The method of clause 31, further comprising: receiving, from the location server, information that associates a RIS with a positioning reference signal (PRS) resource, PRS resource set, transmission reception point (TRP), positioning frequency layer (PFL), or combinations thereof.

Clause 33. An apparatus comprising a memory, at least one transceiver, and at least one processor communicatively coupled to the memory and the at least one transceiver, the at least one processor configured to perform a method in accordance with any of clauses 1 to 30.

Clause 34. An apparatus comprising means for performing a method in accordance with any of clauses 1 to 30.

Clause 35. A computer-readable medium storing computer-executable instructions, the computer-executable instructions comprising at least one instruction for causing an apparatus to perform a method in accordance with any of clauses 1 to 30.

Clause 36. An apparatus comprising a memory, at least one transceiver, and at least one processor communicatively coupled to the memory and the at least one transceiver, the memory, the at least one transceiver, and the at least one processor configured to perform a method according to any of clauses 1 to 32.

Clause 37. An apparatus comprising means for performing a method according to any of clauses 1 to 32.

Clause 38. A non-transitory computer-readable medium storing computer-executable instructions, the computer-executable comprising at least one instruction for causing a computer or processor to perform a method according to any of clauses 1 to 32.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication performed by a network node, the method comprising:
determining an estimated location of a user equipment (UE) that is served by a serving base station (BS);
determining a dilution of precision (DOP) requirement with respect to the UE;
determining at least one reconfigurable intelligent surface (RIS) that satisfies the DOP requirement with respect to the UE, and
sending at least one configuration message to configure the at least one RIS to reflect positioning reference signals to or from the UE.

2. The method of claim 1, wherein determining the DOP requirement comprises determining the DOP requirement based on a quality of service (QoS) requirement associated with the UE.

3. The method of claim 1, wherein the DOP requirement with respect to the UE comprises a geometric DOP requirement, a horizontal DOP requirement, a vertical DOP requirement, a position DOP requirement, a timing DOP requirement, or combinations thereof.

4. The method of claim 1, wherein determining the at least one RIS that satisfies a DOP requirement with respect to the UE comprises:
identifying the at least one RIS that satisfies the DOP requirement with respect to the UE.

5. The method of claim 4, wherein identifying the at least one RIS that satisfies the DOP requirement with respect to the UE comprises selecting the at least one RIS that satisfies the DOP requirement with respect to the UE from a list of RISs with known locations.

6. The method of claim 1, wherein determining the at least one RIS that satisfies a DOP requirement with respect to the UE comprises:
identifying at least one geographical region from which a RIS would satisfy the DOP requirement with respect to the UE;
sending, to a RIS controller, the at least one geographical region;
receiving, from the RIS controller, an identity of at least one RIS within the at least one geographical region; and
determining that the at least one RIS satisfies the DOP requirement with respect to the UE.

7. The method of claim 6, further comprising sending the DOP requirement to the RIS controller, wherein the at least one RIS identified by the RIS controller satisfies the DOP requirement with respect to the UE.

8. The method of claim 6, wherein the RIS controller comprises a base station or a radio access network node.

9. The method of claim 1, wherein determining the at least one RIS that satisfies a DOP requirement with respect to the UE comprises:
sending, to a RIS controller, the estimated location of the UE and the DOP requirement with respect to the UE; and
receiving, from the RIS controller, an identity of at least one RIS that satisfies the DOP requirement with respect to the UE.

10. The method of claim 9, wherein the RIS controller comprises a base station or a radio access network node.

11. The method of claim 1, wherein determining the at least one RIS that satisfies a DOP requirement with respect to the UE comprises:
determining a first set of one or more RISs that satisfy a first DOP requirement with respect to the UE; and
determining a second set of one or more RISs that satisfy a second DOP requirement with respect to the UE.

12. The method of claim 1, wherein sending at least one configuration message to configure the at least one RIS to reflect positioning reference signals to or from the UE comprises sending the at least one configuration message to the at least one RIS.

13. The method of claim 1, wherein sending at least one configuration message to configure the at least one RIS to reflect positioning reference signals to or from the UE comprises sending the at least one configuration message to a network node that controls the at least one RIS.

14. The method of claim 13, wherein sending the at least one configuration message to a network node that controls the at least one RIS comprises sending the at least one configuration message to a base station.

15. The method of claim 1, wherein the at least one configuration message identifies the UE.

16. The method of claim 1, wherein the at least one configuration message indicates a location of the UE.

17. The method of claim 1, wherein the at least one configuration message indicates a direction in which to reflect the positioning reference signals to or from the UE.

18. The method of claim 1, wherein the at least one configuration message indicates a target accuracy level.

19. The method of claim 1, further comprising sending at least one configuration message to configure the serving BS to transmit at least one positioning reference signal to the at least one RIS.

20. The method of claim 1, further comprising receiving at least one configuration response message indicating that the at least one RIS is or is not configured to reflect positioning reference signals to or from the UE.

21. The method of claim 1, wherein the network node comprises a location server.

22. A method of wireless communication performed by a user equipment (UE), the method comprising:
determining a dilution of precision (DOP) requirement with respect to the UE; and
sending at least one configuration message to select at least one RIS that satisfies the DOP requirement with respect to the UE to reflect positioning reference signals to or from the UE.

23. The method of claim 22, wherein determining the DOP requirement comprises determining the DOP requirement based on a quality of service (QoS) requirement associated with the UE.

24. The method of claim 22, wherein the DOP requirement with respect to the UE comprises a geometric DOP requirement, a horizontal DOP requirement, a vertical DOP requirement, a position DOP requirement, a timing DOP requirement, or combinations thereof.

25. The method of claim 22, wherein the at least one configuration message comprises information that identifies at least one RIS that satisfies the DOP requirement with respect to the UE.

26. The method of claim 25, wherein the at least one configuration message further comprises an estimated location of the UE.

27. The method of claim 25, wherein sending at least one configuration message comprises selecting the at least one RIS that satisfies the DOP requirement with respect to the UE and sending the at least one configuration message to the at least one RIS that satisfies the DOP requirement with respect to the UE.

28. The method of claim 22, wherein sending at least one configuration message comprises sending the at least one configuration message to a RIS controller that selects the at least one RIS that satisfies the DOP requirement with respect to the UE.

29. The method of claim 28, wherein the RIS controller comprises a base station or a radio access network node.

30. The method of claim 22, wherein the at least one configuration message comprises the DOP requirement and an estimated location of the UE.

31. The method of claim 22, wherein sending the at least one configuration message comprises sending the at least one configuration message to a location server.

32. The method of claim 31, further comprising:
receiving, from the location server, information that associates a RIS with a positioning reference signal (PRS) resource, PRS resource set, transmission reception point (TRP), positioning frequency layer (PFL), or combinations thereof.

33. A network node, comprising:
a memory,
at least one transceiver; and
at least one processor communicatively coupled to the memory and the at least one transceiver, the at least one processor configured to:
determine an estimated location of a user equipment (UE) that is served by a serving base station (BS);
determine a dilution of precision (DOP) requirement with respect to the UE;
determine at least one reconfigurable intelligent surface (RIS) that satisfies the DOP requirement with respect to the UE; and
send, via the at least one transceiver, at least one configuration message to configure the at least one RIS to reflect positioning reference signals to or from the UE.

34. The network node of claim 33, wherein, to determine the DOP requirement, the at least one processor is configured to determine the DOP requirement based on a quality of service (QoS) requirement associated with the UE.

35. The network node of claim 33, wherein the DOP requirement with respect to the UE comprises a geometric DOP requirement, a horizontal DOP requirement, a vertical DOP requirement, a position DOP requirement, a timing DOP requirement, or combinations thereof.

36. The network node of claim 33, wherein, to determine the at least one RIS that satisfies a DOP requirement with respect to the UE, the at least one processor is configured to:
identify at least one RIS that satisfies the DOP requirement with respect to the UE.

37. The network node of claim 36, wherein, to identify the at least one RIS that satisfies the DOP requirement with respect to the UE, the at least one processor is configured to select the at least one RIS that satisfies the DOP requirement with respect to the UE from a list of RISs with known locations.

38. The network node of claim 33, wherein, to determine the at least one RIS that satisfies a DOP requirement with respect to the UE, the at least one processor is configured to:
identify at least one geographical region from which a RIS would satisfy the DOP requirement with respect to the UE;
send, via the at least one transceiver, to a RIS controller, the at least one geographical region;
receive, via the at least one transceiver, from the RIS controller, an identity of at least one RIS within the at least one geographical region; and
determine that the at least one RIS satisfies the DOP requirement with respect to the UE.

39. The network node of claim 38, wherein the at least one processor is further configured to send, via the at least one transceiver, the DOP requirement to the RIS controller, wherein the at least one RIS identified by the RIS controller satisfies the DOP requirement with respect to the UE.

40. The network node of claim 38, wherein the RIS controller comprises a base station or a radio access network node.

41. The network node of claim 33, wherein, to determine the at least one RIS that satisfies a DOP requirement with respect to the UE, the at least one processor is configured to:
send, via the at least one transceiver, to a RIS controller, the estimated location of the UE and the DOP requirement with respect to the UE; and
receive, via the at least one transceiver, from the RIS controller, an identity of at least one RIS that satisfies the DOP requirement with respect to the UE.

42. The network node of claim 41, wherein the RIS controller comprises a base station or a radio access network node.

43. The network node of claim 33, wherein, to determine the at least one RJS that satisfies a DOP requirement with respect to the UE, the at least one processor is configured to:
determine a first set of one or more RISs that satisfy a first DOP requirement with respect to the UE; and
determine a second set of one or more RISs that satisfy a second DOP requirement with respect to the UE.

44. The network node of claim 33, wherein, to send at least one configuration message to configure the at least one RIS to reflect positioning reference signals to or from the UE, the at least one processor is configured to send the at least one configuration message to the at least one RIS.

45. The network node of claim 33, wherein, to send at least one configuration message to configure the at least one RIS to reflect positioning reference signals to or from the UE, the at least one processor is configured to send the at least one configuration message to a network node that controls the at least one RIS.

46. The network node of claim 45, wherein, to send the at least one configuration message to a network node that controls the at least one RIS, the at least one processor is configured to send the at least one configuration message to a base station.

47. The network node of claim 33, wherein the at least one configuration message identifies the UE.

48. The network node of claim 33, wherein the at least one configuration message indicates a location of the UE.

49. The network node of claim 33, wherein the at least one configuration message indicates a direction in which to reflect the positioning reference signals to or from the UE.

50. The network node of claim 33, wherein the at least one configuration message indicates a target accuracy level.

51. The network node of claim 33, wherein the at least one processor is further configured to send, via the at least one transceiver, at least one configuration message to configure the serving BS to transmit at least one positioning reference signal to the at least one RIS.

52. The network node of claim 33, wherein the at least one processor is further configured to receive, via the at least one transceiver, at least one configuration response message indicating that the at least one RIS is or is not configured to reflect positioning reference signals to or from the UE.

53. The network node of claim 33, wherein the network node comprises a location server.

54. A user equipment (UE), comprising:
a memory;
at least one transceiver; and
at least one processor communicatively coupled to the memory and the at least one transceiver, the at least one processor configured to:
determine a dilution of precision (DOP) requirement with respect to the UE; and
send, via the at least one transceiver, at least one configuration message to select at least one RIS that satisfies the DOP requirement with respect to the UE to reflect positioning reference signals to or from the UE.

55. The UE of claim 54, wherein, to determine the DOP requirement, the at least one processor is configured to determine the DOP requirement based on a quality of service (QoS) requirement associated with the UE.

56. The UE of claim 54, wherein the DOP requirement with respect to the UE comprises a geometric DOP requirement, a horizontal DOP requirement, a vertical DOP requirement, a position DOP requirement, a timing DOP requirement, or combinations thereof.

57. The UE of claim 54, wherein the at least one configuration message comprises information that identifies at least one RIS that satisfies the DOP requirement with respect to the UE.

58. The UE of claim 57, wherein the at least one configuration message further comprises an estimated location of the UE.

59. The UE of claim 57, wherein, to send at least one configuration message, the at least one processor is configured to select the at least one RIS that satisfies the DOP requirement with respect to the UE and sending the at least one configuration message to the at least one RIS that satisfies the DOP requirement with respect to the UE.

60. The UE of claim 54, wherein, to send at least one configuration message, the at least one processor is configured to send the at least one configuration message to a RIS controller that selects the at least one RIS that satisfies the DOP requirement with respect to the UE.

61. The UE of claim 60, wherein the RIS controller comprises a base station or a radio access network node.

62. The UE of claim 54, wherein the at least one configuration message comprises the DOP requirement and an estimated location of the UE.

63. The UE of claim 54, wherein, to send the at least one configuration message, the at least one processor is configured to send the at least one configuration message to a location server.

64. The UE of claim 63, wherein the at least one processor is further configured to:
receive, via the at least one transceiver, from the location server, information that associates a RIS with a positioning reference signal (PRS) resource, PRS resource set, transmission reception point (TRP), positioning frequency layer (PFL), or combinations thereof.

65. A network node, comprising:
means for determining an estimated location of a user equipment (UE) that is served by a serving base station (BS);
means for determining a dilution of precision (DOP) requirement with respect to the UE;
means for determining at least one reconfigurable intelligent surface (RIS) that satisfies the DOP requirement with respect to the UE; and
means for sending at least one configuration message to configure the at least one RIS to reflect positioning reference signals to or from the UE.

66. The network node of claim 65, wherein the means for determining the DOP requirement comprises means for determining the DOP requirement based on a quality of service (QoS) requirement associated with the UE.

67. The network node of claim 65, wherein the DOP requirement with respect to the UE comprises a geometric DOP requirement, a horizontal DOP requirement, a vertical DOP requirement, a position DOP requirement, a timing DOP requirement, or combinations thereof.

68. The network node of claim 65, wherein the means for determining the at least one RIS that satisfies a DOP requirement with respect to the UE comprises:
means for identifying the at least one RIS that satisfies the DOP requirement with respect to the UE.

69. The network node of claim 68, wherein the means for identifying the at least one RIS that satisfies the DOP requirement with respect to the UE comprises means for selecting the at least one RIS that satisfies the DOP requirement with respect to the UE from a list of RISs with known locations.

70. The network node of claim 65, wherein the means for determining the at least one RIS that satisfies a DOP requirement with respect to the UE comprises:
means for identifying at least one geographical region from which a RIS would satisfy the DOP requirement with respect to the UE;
means for sending, to a RIS controller, the at least one geographical region;
means for receiving, from the RIS controller, an identity of at least one RIS within the at least one geographical region; and
means for determining that the at least one RIS satisfies the DOP requirement with respect to the UE.

71. The network node of claim 70, further comprising means for sending the DOP requirement to the RIS controller, wherein the at least one RIS identified by the RIS controller satisfies the DOP requirement with respect to the UE.

72. The network node of claim 70, wherein the RIS controller comprises a base station or a radio access network node.

73. The network node of claim 65, wherein the means for determining the at least one RIS that satisfies a DOP requirement with respect to the UE comprises:
means for sending, to a RIS controller, the estimated location of the UE and the DOP requirement with respect to the UE; and
means for receiving, from the RIS controller, an identity of at least one RiS that satisfies the DOP requirement with respect to the UE.

74. The network node of claim 73, wherein the RIS controller comprises a base station or a radio access network node.

75. The network node of claim 65, wherein the means for determining the at least one RIS that satisfies a DOP requirement with respect to the UE comprises:
means for determining a first set of one or more RISs that satisfy a first DOP requirement with respect to the UE; and
means for determining a second set of one or more RISs that satisfy a second DOP requirement with respect to the UE.

76. The network node of claim 65, wherein the means for sending at least one configuration message to configure the at least one RIS to reflect positioning reference signals to or from the UE comprises means for sending the at least one configuration message to the at least one RIS.

77. The network node of claim 65, wherein the means for sending at least one configuration message to configure the at least one RIS to reflect positioning reference signals to or from the UE comprises means for sending the at least one configuration message to a network node that controls the at least one RIS.

78. The network node of claim 77, wherein the means for sending the at least one configuration message to a network node that controls the at least one RIS comprises means for sending the at least one configuration message to a base station.

79. The network node of claim 65, wherein the at least one configuration message identifies the UE.

80. The network node of claim 65, wherein the at least one configuration message indicates a location of the UE.

81. The network node of claim 65, wherein the at least one configuration message indicates a direction in which to reflect the positioning reference signals to or from the UE.

82. The network node of claim 65, wherein the at least one configuration message indicates a target accuracy level.

83. The network node of claim 65, further comprising means for sending at least one configuration message to configure the serving BS to transmit at least one positioning reference signal to the at least one RIS.

84. The network node of claim 65, further comprising means for receiving at least one configuration response message indicating that the at least one RIS is or is not configured to reflect positioning reference signals to or from the UE.

85. The network node of claim 65, wherein the network node comprises a location server.

86. A user equipment (UE), comprising:
means for determining a dilution of precision (DOP) requirement with respect to the UE; and
means for sending at least one configuration message to select at least one RIS that satisfies the DOP requirement with respect to the UE to reflect positioning reference signals to or from the UE.

87. The UE of claim 86, wherein the means for determining the DOP requirement comprises means for determining the DOP requirement based on a quality of service (QoS) requirement associated with the UE.

88. The UE of claim 86, wherein the DOP requirement with respect to the UE comprises a geometric DOP requirement, a horizontal DOP requirement, a vertical DOP requirement, a position DOP requirement, a timing DOP requirement, or combinations thereof.

89. The UE of claim 86, wherein the at least one configuration message comprises information that identifies at least one RIS that satisfies the DOP requirement with respect to the UE.

90. The UE of claim 89, wherein the at least one configuration message further comprises an estimated location of the UE.

91. The UE of claim 89, wherein the means for sending at least one configuration message comprises means for selecting the at least one RIS that satisfies the DOP requirement with respect to the UE and sending the at least one configuration message to the at least one RIS that satisfies the DOP requirement with respect to the UE.

92. The UE of claim 86, wherein the means for sending at least one configuration message comprises means for sending the at least one configuration message to a RIS controller that selects the at least one RIS that satisfies the DOP requirement with respect to the UE.

93. The UE of claim 92, wherein the RIS controller comprises a base station or a radio access network node.

94. The UE of claim 86, wherein the at least one configuration message comprises the DOP requirement and an estimated location of the UE.

95. The UE of claim 86, wherein the means for sending the at least one configuration message comprises means for sending the at least one configuration message to a location server.

96. The UE of claim 95, further comprising:
means for receiving, from the location server, information that associates a RIS with a positioning reference signal (PRS) resource, PRS resource set, transmission reception point (TRP), positioning frequency layer (PFL), or combinations thereof.

97. A non-transitory computer-readable medium storing computer-executable instructions that, when executed by a network node, cause the network node to:
determine an estimated location of a user equipment (UE) that is served by a serving base station (BS);
determine a dilution of precision (DOP) requirement with respect to the UE;
determine at least one reconfigurable intelligent surface (RIS) that satisfies the DOP requirement with respect to the UE; and
send at least one configuration message to configure the at least one RIS to reflect positioning reference signals to or from the UE.

98. The non-transitory computer-readable medium of claim 97, wherein, to determine the DOP requirement, the computer-executable instructions cause the network node to determine the DOP requirement based on a quality of service (QoS) requirement associated with the UE.

99. The non-transitory computer-readable medium of claim 97, wherein the DOP requirement with respect to the UE comprises a geometric DOP requirement, a horizontal DOP requirement, a vertical DOP requirement, a position DOP requirement, a timing DOP requirement, or combinations thereof.

100. The non-transitory computer-readable medium of claim 97, wherein, to determine the at least one RIS that satisfies a DOP requirement with respect to the UE, the computer-executable instructions cause the network node to:
identify at least one RIS that satisfies the DOP requirement with respect to the UE.

101. The non-transitory, computer-readable medium of claim 100, wherein, to identify the at least one RIS that satisfies the DOP requirement with respect to the UE, the computer-executable instructions cause the network node to select the at least one RIS that satisfies the DOP requirement with respect to the UE from a list of RISs with known locations.

102. The non-transitory computer-readable medium of claim 97, wherein, to determine the at least one RIS that satisfies a DOP requirement with respect to the UE, the computer-executable instructions cause the network node to:
identify at least one geographical region from which a RIS would satisfy the DOP requirement with respect to the UE;
send, to a RIS controller, the at least one geographical region;
receive, from the RIS controller, an identity of at least one RIS within the at least one geographical region; and
determine that the at least one RIS satisfies the DOP requirement with respect to the UE.

103. The non-transitory computer-readable medium of claim 102, wherein the one or more instructions further cause the network node to send the DOP requirement to the RIS controller, wherein the at least one RIS identified by the RIS controller satisfies the DOP requirement with respect to the UE.

104. The non-transitory computer-readable medium of claim 102, wherein the RIS controller comprises a base station or a radio access network node.

105. The non-transitory computer-readable medium of claim 97, wherein, to determine the at least one RIS that satisfies a DOP requirement with respect to the UE, the computer-executable instructions cause the network node to:
send, to a RIS controller, the estimated location of the UE and the DOP requirement with respect to the UE; and
receive, from the RIS controller, an identity of at least one RIS that satisfies the DOP requirement with respect to the UE.

106. The non-transitory computer-readable medium of claim 105, wherein the RIS controller comprises a base station or a radio access network node.

107. The non-transitory computer-readable medium of claim 97, wherein, to determine the at least one RIS that satisfies a DOP requirement with respect to the UE, the computer-executable instructions cause the network node to:
determine a first set of one or more RISs that satisfy a first DOP requirement with respect to the UE, and
determine a second set of one or more RISs that satisfy a second DOP requirement with respect to the UE.

108. The non-transitory computer-readable medium of claim 97, wherein, to send at least one configuration message to configure the at least one RIS to reflect positioning reference signals to or from the UE, the computer-executable instructions cause the network node to send the at least one configuration message to the at least one RIS.

109. The non-transitory computer-readable medium of claim 97, wherein, to send at least one configuration message to configure the at least one RIS to reflect positioning reference signals to or from the UE, the computer-executable instructions cause the network node to send the at least one configuration message to a network node that controls the at least one RIS.

110. The non-transitory computer-readable medium of claim 109, wherein, to send the at least one configuration message to a network node that controls the at least one RIS, the computer-executable instructions cause the network node to send the at least one configuration message to a base station.

111. The non-transitory computer-readable medium of claim 97, wherein the at least one configuration message identifies the UE.

112. The non-transitory computer-readable medium of claim 97, wherein the at least one configuration message indicates a location of the UE.

113. The non-transitory computer-readable medium of claim 97, wherein the at least one configuration message indicates a direction in which to reflect the positioning reference signals to or from the UE.

114. The non-transitory computer-readable medium of claim 97, wherein the at least one configuration message indicates a target accuracy level.

115. The non-transitory computer-readable medium of claim 97, wherein the one or more instructions further cause the network node to send at least one configuration message to configure the serving BS to transmit at least one positioning reference signal to the at least one RIS.

116. The non-transitory computer-readable medium of claim 97, wherein the one or more instructions further cause the network node to receive at least one configuration response message indicating that the at least one RIS is or is not configured to reflect positioning reference signals to or from the UE.

117. The non-transitory computer-readable medium of claim 97, wherein the network node comprises a location server.

118. A non-transitory computer-readable medium storing computer-executable instructions that, when executed by a user equipment (UE), cause the UE to:
determine a dilution of precision (DOP) requirement with respect to the UE; and
send at least one configuration message to select at least one RIS that satisfies the DOP requirement with respect to the UE to reflect positioning reference signals to or from the UE.

119. The non-transitory computer-readable medium of claim 118, wherein, to determine the DOP requirement, the computer-executable instructions cause the UE to determine the DOP requirement based on a quality of service (QoS) requirement associated with the UE.

120. The non-transitory computer-readable medium of claim 118, wherein the DOP requirement with respect to the UE comprises a geometric DOP requirement, a horizontal DOP requirement, a vertical DOP requirement, a position DOP requirement, a timing DOP requirement, or combinations thereof.

121. The non-transitory computer-readable medium of claim 118, wherein the at least one configuration message comprises information that identifies at least one RIS that satisfies the DOP requirement with respect to the UE.

122. The non-transitory computer-readable medium of claim 121, wherein the at least one configuration message further comprises an estimated location of the UE.

123. The non-transitory computer-readable medium of claim 121, wherein, to send at least one configuration message, the computer-executable instructions cause the UE to select the at least one RIS that satisfies the DOP requirement with respect to the UE and sending the at least one configuration message to the at least one RIS that satisfies the DOP requirement with respect to the UE.

124. The non-transitory computer-readable medium of claim 118, wherein, to send at least one configuration message, the computer-executable instructions cause the UE to send the at least one configuration message to a RIS controller that selects the at least one RIS that satisfies the DOP requirement with respect to the UE.

125. The non-transitory computer-readable medium of claim 124, wherein the RIS controller comprises a base station or a radio access network node.

126. The non-transitory computer-readable medium of claim 118, wherein the at least one configuration message comprises the DOP requirement and an estimated location of the UE.

127. The non-transitory computer-readable medium of claim 118, wherein, to send the at least one configuration message, the computer-executable instructions cause the UE to send the at least one configuration message to a location server.

128. The non-transitory computer-readable medium of claim 127, wherein the one or more instructions further cause the UE to:
receive, from the location server, information that associates a RIS with a positioning reference signal (PRS) resource, PRS resource set, transmission reception point (TRP),
positioning frequency layer (PFL), or combinations thereof.
